(19) United States
(12) Patent Application Publication
(10) Pub. No.: US 2005/0086663 A1
(43) Pub. Date: Apr. 21, 2005

(54) Automation object and method for writing information into an automation object

(76) Inventors: Wolfgang Fritsch, Erlangen (DE); Roman Hodek, Erlangen (DE); Guido Seeger, Baiersdorf (DE); Till-Christian Siering, Forchheim (DE)

Correspondence Address: WHITE & CASE LLP;PATENT DEPARTMENT, 1155 AVENUE OF THE AMERICAS, NEW YORK, NY, 10036, US

(21) Appl. No.: 10/941,380

(22) Filed: Sep. 15, 2004

(30) Foreign Application Priority Data
Sep. 15, 2003 (DE) 103 42 591.8

(51) Int. Cl. G06F 9/00

(52) U.S. Cl. 719/310

(57) ABSTRACT

The invention relates to an automation object (1, 3) which can be connected for data processing to at least one further automation object (1, 3). The automation object (1. 3) has an object-specific information item, it being possible to transfer this object-specific information item to the further automation object (1, 3). The object-specific information is present in a metalanguage or in a form which can be converted into a metalanguage. The invention also relates to a corresponding method in which object-specific information is transmitted from one automation object to another automation object (1, 3)

The present invention relates to an automation object and to a method for writing information into an automation object. An automation object is, for example, a numerical control (CNC), a motion controller, a stored programmable controller (SPS or PLC), a drive, in particular an electric drive, a sensor, a converter, a power converter or other hardware components which are used for automation. An automation object is both a hardware object and a software object, a software object being, for example, a rotational speed controller, a slip controller, a torque controller or other open-loop or closed-loop controllers which are used for an automation purpose.

In order to be able to use such an automation object, its attributes must be known or at least the attributes of the corresponding interface must be known. The interface is in particular a software interface. This knowledge is generally stipulated in the form of documents or machine-readable files at the time of creation of the automation object and distributed to all the users of the automation object or made available by data processing means. These “users”, referred to as clients, are usually other software automation objects in another piece of hardware into which the knowledge or the information can be introduced, or else other hardware automation objects. Documented information is usually programmed into a program, and machine-readable interface descriptions are entered in compiled form or else the descriptions are loaded into the clients from a programming device (PG) whose software contains the knowledge.

If an interface of an automation object such as a controller changes, for example because a functionality is added, expanded, reduced or changed in some other way, the information relating to this has to be updated by the clients. This may result in a situation in which the software of the clients has to be exchanged or at least one new “configuration” has to be loaded. Both methods are complicated and subject to errors, in particular if a large number of clients are affected. If they are not carried out correctly, the system which has a plurality of automation objects goes into an inconsistent state and the behavior is no longer predictable. There may even be damage to machinery or injury to persons because messages from the client are incorrectly displayed or the wrong functions are triggered in the controllers. These problems are caused in particular by the replacement of automation objects which are not identical in terms of their interface. Even one different parameter is enough to change the interface.

This problem has hitherto been solved, for example, by transferring the attributes of the controllers into what are referred to as “device description files” as “device master data”. These files are interpreted by a configuration tool which is suitable for the controller, and are converted into configuration information which the client understands. This configuration information is loaded into the client in an activation step, as a result of which the client is provided with the knowledge of how to carry out the access operations correctly. If this loading step is forgotten, the client can, however, not make access operations or, if he still has outdated information, he could make incorrect access operations. This procedure is therefore subject to error, in particular because the client must receive all of the information without errors and the device master data, which are present, for example, in a type of list, have to be overwritten completely. If the list changes, not only with respect to the data information contained but also with respect to its length, this can lead to interpretation errors.

Simple data descriptions and interpretations in the client, which can be loaded during the running time of an automation object, for example a description of what is referred to as the “machine data” of a numerical controller in a format provided for that purpose are known. Here, some of the interface is described in a machine-readable fashion using a data attribute table. The table is automatically replaced when the controller changes. The client can load this table from the controller at any time, as a result of which a reconciliation between the controller and client can take place during the running time and the client must only have a small amount of prior knowledge. However, in order to be able to operate efficiently, the format is very rigid, cannot be expanded and can also only describe simple data types. Furthermore, owing to the lack of versioning, it requires the client to do loading processes relatively frequently, forcing the user to wait.

Given the increasing complexity of programmable control systems and installations which have automation objects, it is becoming more and more difficult to replace one or more automation objects since the versions of automation objects are changing more and more frequently and as a result their interface or their object-specific information also changes.

One possible way of fulfilling these increasing requirements would be to integrate more and more protection functions in an automation installation in order to prevent errors. However, these functions are complex and take up resources.

The objective of the present invention is to improve an automation object, in particular with respect to object-specific information. Furthermore, the data information of an automation object has to be improved with respect to an object-specific information item. As a result, a higher degree of automation can be achieved.

This objective is achieved by means of an automation object having the features specified in claim 1. Advantageous refinements and developments emerge from the dependent claims 2 to 7. Claim 8 relates to a method for describing information of an automation object and also fulfills the objective by means of its features. Advantageous refinements and developments of the method result from the subclaims 9 to 13.

According to the invention, an automation object can be connected to a further automation object for data processing. The automation object having an object-specific information item or it being possible to transfer the object-specific information item to the further automation object, the object-specific information being present in a metalanguage or in a form which can be converted into a metalanguage.

The object-specific information is therefore present in a defined format, this defined format being a standardized metalanguage such as XML. The form which can be converted into a metalanguage is in particular a compact, expandable format which can be interpreted with few resources. The format is in particular a format which is internal to the controller, can be converted into and from XML without loss and has the purpose of exchanging data and data descriptions. The conversion of the format from and into XML is advantageously carried out simply and quickly.

The format has, for example, a header. In this header, for example bits for a version identification can be provided. Furthermore, other bits can be provided for further functions.

The header is followed, for example, by a route tag. This route tag contains the entire data content as a compound tag. In particular, only one route tag is permissible per format file. A data tag has, for example, its own header.

For example, the automation object is, as described above, a software object or a hardware object. An automation component such as a motor or a stored-programmable controller is a hardware object.

Functions of programmable controllers such as numerical controllers (CNCs), motion controllers and stored-programmable controllers (PLCs) as well as drives and intelligent sensors present themselves to the outside, i.e. to the next superordinate or subordinate or adjacent automation object or to the user as an automation object with an interface. This interface has, for example, functions which can be called and also data values which can be read or written. An automation object is, for example, predefined, for example in the case of an electric machine which has machine data, or are defined firstly by a user and loaded into the controller.

Technical attributes of devices such as the maximum rotational speed of a motor or the weighted current are frequently stored in conventional databases.

If new products or new rules are to be incorporated, the respective catalogue must be issued again and the respective software must be compiled again.

This results in a series of problems. For example, previous configuration methods cannot be compared with one another. Furthermore, previous configuration methods cannot be combined with one another.

The term “metalanguage” stands for the definition or description of a language. The metalanguage describes the rules for generating a language. The “Standard Generalized Markup Language” (SGML), for example, is referred to as a metalanguage because it is a language for describing languages. It specifies the rules as to how a document can be described in its logical structure (headings, paragraphs, content units, etc.) XML (extensible markup language) is a subset of SGML and is therefore also a metalanguage for defining document types. By using a metalanguage such as SGML and XML it is possible to create documents which all comply with the same basic patterns in terms of their structure.

This will be described below by way of example with reference to XML solely for the purpose of simplifying the representation and explanation of the invention.

A significant advantage of XML is that a strict separation is made between the content, representation and structure of data. This is achieved by means of the possibility of defining tags in XML files which can in turn contain tags. As a result, an XML file can build up a tree which leads to a structured separation of various content items. This ensures the basis for machine processing of the file.

By using various XSL files (XSL=extensible stylesheet language) it is possible for an XML document to assume different representations. For the conversion from an XML document into another document, XSLT (extensible stylesheet language for transformations) is used. Application areas for XSLT may be the conversion of XML files into HTML (hypertext markup language) or XHTML (extensible hypertext markup language) but also into free format.

In one advantageous embodiment, the object-specific information has a hierarchical structure. The metalanguage can be used particularly advantageously for the hierarchical structure since it can form a type of tree structure which can be used to structure and store the information in a hierarchical fashion. The hierarchical structure makes it possible to transmit additional information which is not yet available in itself by means of the data which is stored hierarchically. For example, when there is a configuration of drive systems which have various automation objects such as motors and drives with power converters, there are a large number of interfaces present. The interfaces relate also in particular to physical attributes such as temperature characteristic curves in the case of electric motors, rated currents, rated voltages, maximum rotational speed, rated currents etc.

In one advantageous refinement, the automation object 25 itself has its own object-specific information. If an automation object is therefore replaced or newly integrated into a structure composed of various automation objects which are linked for data processing, the automation object which is added always carries with it a self-description of at least essential information which can be read by further automation objects which are also connected thereto for data processing.

In one advantageous refinement, the metalanguage is a standardized XML language which is known by the name MathML. As a result, in particular technical attributes of automation objects which are to be used can be used together with the rules and methods or prescriptions. System knowledge can also be stored in this way.

This MathML specification was created in order to make mathematical relationships available in XML. Details of this specification can be found at the Internet Address http://www.w3.org/TR/MathML2. This specification is used as a basis for describing system knowledge in the field of drive technology.

The MathML specification which is known per se is advantageously expanded in a suitable way in order to describe system knowledge in the field of drive technology. For example, the MathML specification which is expanded according to one development of the invention also comprises strings which are not provided in the standardized MathML specification. Strings are chains of characters with which computing processes cannot be performed. Such chains of characters may correspond, for example, to order numbers, product names or PAL color tones.

A further advantageous development of the invention is to use an expanded MathML specification which also comprises freely defined operators. Such operators may specify definition features of functions. As a result, for example, it is possible to specify a rule according to which a given function is not defined for all values of a variable which are greater than a given threshold value.

The automation object, for example a controller, which can be addressed by an automation object, for example a client, has, for example, as object-specific information a self-description which covers, in particular, frequently changing aspects of the automation object and which can be loaded from the controller during the running time. In the self-description it is possible to store, for example, predefined and user-defined data, messages, program instructions, function calls together with a signature, the vocabulary of the programming language of the controller etc., even visualizing aspects or similar instructions which control the behavior of the client. The self-description advantageously has, for example, at least one of the following attributes:

Expandability through upward compatibility; as a result new attributes can be added and described without the old ones which are already present becoming unreadable.

A self-description of the format, in the form of a version as well as further optional information.

Detectability of changes of the content by the client so that it is always clear whether the client has reloaded the description.

The self-description is always replaced together with the objects which are described by it.

The self-description can be located and loaded with a method which is simple for the client.

The self-description is very compact thanks to the use of the binary format, and as a result takes up little memory space as well as during storage transportation and processing.

The self-description is efficient both by virtue of the use of the metalanguage and can be interpreted with little computing power and by means of compact storage in the binary format, which is efficient through being aimed at efficient reading and interpreting.

The self-description can be converted into an XML format, and back again, without loss. All the attributes can be created in the XML format and then converted, into the self-description.

For the application for the self-description of automation components only a subset of the scope of the XML language has to be supported and not the entire scope of the XML language.

The self-description can also be applied to objects of operator controls.

In one embodiment, the client or the automation object only has to provide the knowledge as to how the self-description or the object-specific information is to be found, how it is to be read out of the controller and interpreted, and how it is possible to detect when the description is to be re-read or re-interpreted because it has changed. Otherwise, largely “generic” working is possible, i.e. operation with a very large number of controllers is appropriate without providing A-priori knowledge about each specific element. Neither specific client software versions nor particular loading processes of drivers or device descriptions have to be made by way of preparation. Different versions of controllers which are active simultaneously are also easily coped with since the client sets itself automatically to the attributes of the device.

As a result, it is also relatively easy to construct clients for remote diagnosis and remote maintenance since only one generic client has to be installed at the remote location and this client co-operates with all the controllers located “in the field”, i.e. at the user end as long as the method for handling the self-description does not change in an incompatible way. In contrast to the WEB browser which is often proposed in this context as a generic client, the controller is, however, loaded to a significantly smaller degree by visualization aspects (languages, fonts, windows, masks, input methods, operator control logic, operator control speed etc.) which can continue to be handled in a client-specific fashion and thus adapted to the requirements of the respective user. As a result better operator control (usability) is attained than with the web browser concept. The object-specific information is advantageously stored in a binary format or in an ASCI format. The presence of the object-specific information in a binary format has the advantage that this binary format requires little memory space. The advantage of the ASCI format is that it is the format which can be read by a person. Each format can be converted into the other.

The objective of improving an automation system in particular with respect to object-specific information is resolved by a method for describing information of an automation object. According to said method, at least one first automation object is connected to a second automation object for data processing. An object-specific information item, which is present in a metalanguage or in a form which can be converted into a metalanguage is transmitted from a first automation object to the second automation object. The object-specific information having in particular a hierarchical structure. An object-specific information item which describes this first automation object is advantageously stored in the first automation object. This object-specific information is provided for data transmission to the second automation object, this object-specific information being stored in the second automation object. As a result it is possible to build up a networked structure, automation objects in this structure, which is networked in terms of data processing, containing information about further automation objects.

In one advantageous refinement, an automation object detects a change with respect to hardware or software attributes of a further automation object, the automation objects being connected to one another. The change in the attribute of the changed automation object is detected by means of a data reconciliation. After this, the object-specific information of the changed automation object is transmitted to the object which has detected this change. In particular in the case of software updates or replacement deliveries that there are in the case when automation objects are exchanged it is ensured that frictionless functioning of the entire system of automation objects continues to be ensured in data processing grouping of automation objects, since the automation objects advantageously have information which is specific to each automation object and which can be transmitted to automation objects which require this information.

The object-specific information is advantageously transmitted in an initialization mode of the second automation object. Since initialization is usually carried out when automation objects are exchanged or there is a software update of an automation object, the object-specific data of the automation objects which are coupled for data processing to an automation object are to be advantageously tested during each initialization in a corresponding initialization mode.

By using the automation object according to the invention or the method according to the invention it is possible in particular to achieve at least one of the following advantages described by way of example:

a) As a result of the flexibility of the format, a very large number of object attributes can be expressed in the self-description, even those of complex objects and those of objects which are very different in design. As a result, a very large number of properties of the controller can be addressed “generically”. It is often necessary to change only the controller and not the client in order to make a function completely usable. This saves a large amount of development effort, breaks up the development stream and hugely simplifies the management of software versions “in the field”, i.e. at the user end.

b) The upwardly compatible expansion means that even old clients which understand only some of the self-description still interact in a meaningful way with new controllers. The interaction is not entirely rejected but the “version conflict” is as far as possible resolved, specifically with a slight restriction of the functionality.

c) The self-description of the format permits even changes which are not upwardly compatible to be defined. Misinterpretations are reliably avoided.

d) By means of the unambiguous “stamping” of the self-description at every change, the client can reliably detect whether it has loaded a current description into itself. For this reason, it can keep a copy of the description which it can access more quickly and it can even convert it in order to filter out aspects which are only of interest to it or to make the access even more efficient, and nevertheless always knows when it must reject this copy and its derivatives and build up a new description. As a result, the description is always transmitted precisely at the moment when it is actually necessary without a human having to intervene. Consistency is automatically ensured, as is efficient processing. This applies even if the clients communicate with one controller for some of the time and with the other controller for the rest of the time since the clients always check the stamping before the access operation.

e) Since the self-description is always exchanged together with the objects, it always matches the object and always permits the correct access operation. This simultaneous exchange is carried out in one and the same component (of the controller which contains the object) and is thus very easy to make “foolproof”. The stamping (see previous point) then ensures that all the clients always also hold a suitable description. The control supports the clients by “publishing changes to the stamps to all clients which are signed on (connected to it).

f) As a result of the simple localization of the description (for example by means of a directory or name conventions or a browsing interface which is always present), the client can automatically detect which objects are present in the controller and how it can address them. It does not need to know a priori which objects there are. As a result, in particular objects which are defined by the user, such as programs, program variables, messages and the like, can be handled without knowledge having to be previously loaded into the client. This is particularly important for diagnostic scenarios since this knowledge (the “configuration of the controller) is often not accessible here or does not match the controller.

g) As a result of the compactness of the description, the self-description can mainly only be implemented in a cost effective way. Otherwise a storage requirement which was higher by several factors and a higher communication bandwidth would have to be allowed for, entailing correspondingly unrealistic product prices. For these reasons, for example XML formats can be used only rarely in automation devices despite the elegance and flexibility of such formats. It is important that the approach scales as far as possible “downward” in the direction of small devices, so that it can also be used comprehensively for example in intelligent sensors, small drives and small controllers.

h) Efficient processing of the description is important so that even small clients, for example simple operator controls with little storage and low computing power can implement the concept. XML formats would also be incompatible in this respect since they require complex parsers and the information has to be found by sequential reading through, while efficient coding of the description also permits non linear processing.

i) Converting from and into XML gives rise to almost all the advantages which XML formats provide without subjecting the controllers to the running time disadvantages. As a result, the description information can firstly be generated in XML form, possibly read and interpreted by people, and further processed and archived using XML standard tools. As a result of the conversion into a more efficient format, the controller nevertheless receives only the “essence” of the description, not the “padding” of the XML syntax for machine processing. Conversely, a description which is loaded from the controller can always be converted into XML where this is advantageous for further processing.

j) Describing objects of operator controls appears nonsensical in the first instance since they usually occur as clients and read the description of other devices. However, there are a number of cases in which operator controls themselves have to operate other clients, for example when performing remote diagnostics, or when updating or configuring objects of the operator controls. In this sense, an operator control is also an intelligent automation component and should therefore be able to supply a self-description at least of the most important objects.

In a further refinement, the following services can also be implemented:

Automatic detection as to whether the client has the correct object description.

Automatic detection of the client as to whether the automation component has changed.

If a change is detected, the object-specific information is loaded into the client; if appropriate automatic conversion and storage of this object-specific information.

A description-interpreter extracts the necessary object-specific information, it being possible to add on this information in a format which can be read by a user.

The client or the application uses the information about the object-specific information to communicate with the automation component.

By using, for example, XML as a metalanguage, the object-specific information can both be read by people and also machines. This makes a database much easier to manage. This management can also be carried out in particular by persons who are neither XML nor software specialists, by using one of the numerous known XML editors. Furthermore, an electronic processability of the system knowledge is ensured at all times. No translation is necessary at the interface between man and machine.

Finally, the rules can also be stored, in the same way as the technical details, as text in databases. The entire knowledge about object-specific information can thus be handled by means of a uniform data management system.

In particular, owing to the universality of XML or of metalanguages—particularly also in the Internet—said knowledge can be expanded at any time and also used in electronic sales and marketing forms.

Further advantageous attributes of the invention will become apparent from their exemplary explanation with reference to the drawing, in which:

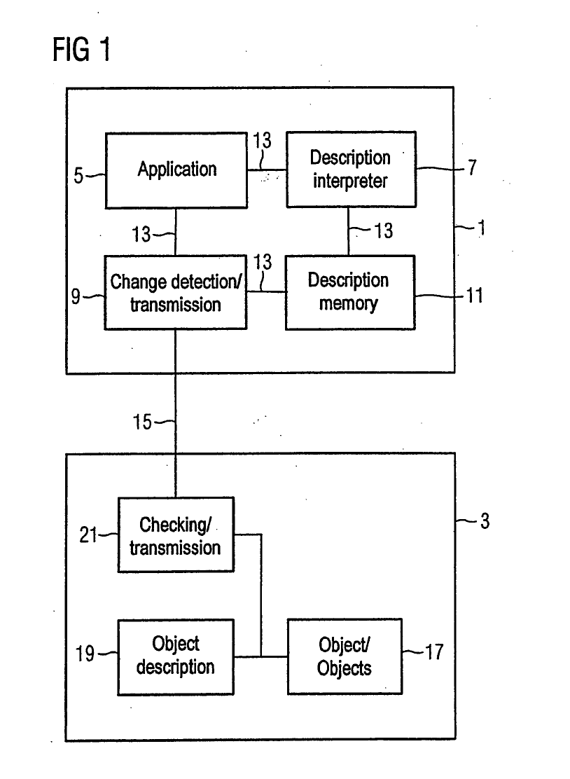

FIG. 1 shows two automation objects which are connected to one another for data processing, and

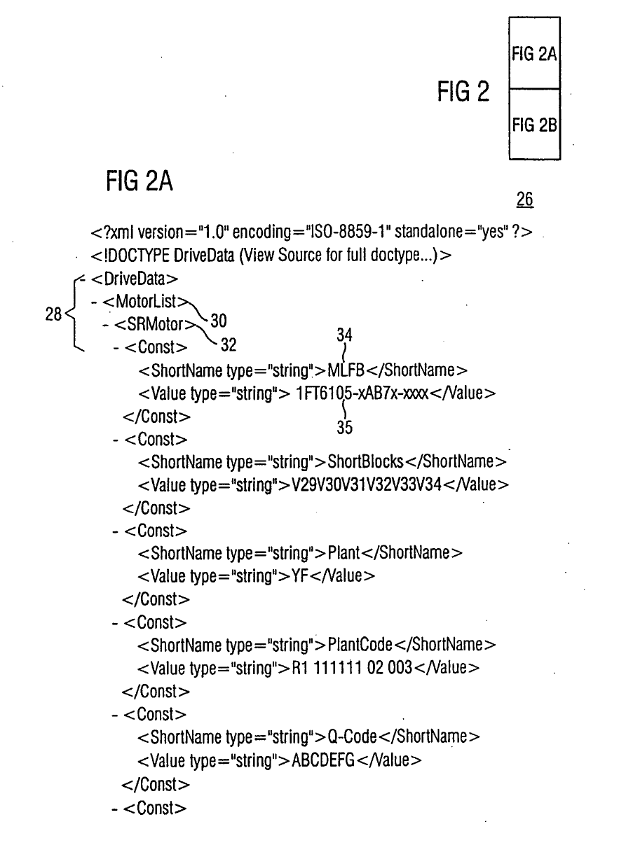

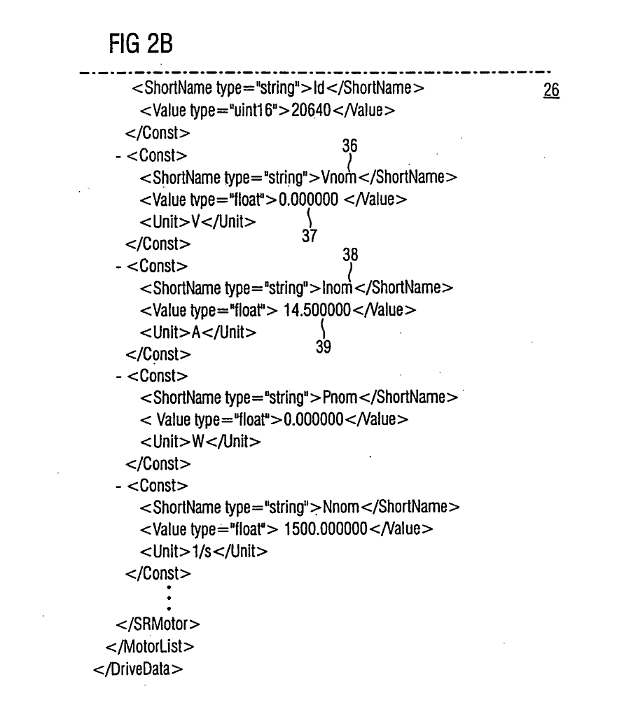

FIG. 2 shows an object-specific information item in a metalanguage.

The illustration in FIG. 1 shows a client 1 as a first automation object and an automation component 3 as a second automation object. The client 1 has software modules. A software module is, for example, an application 5, a description interpreter 7, a description memory 11 and a communications module 9. The modules 5, 7, 9 and 11 are connected to one another for data processing via communications links 13. The connection to the second automation object 3 is made via the communications module 9 by means of a data transmission means 15. The data transmission means 15 is, for example, a bus cable or else a radio link.

The automation component 3 has a software-based automation object 17, as well as an object-specific information item 19 and an interface module 21. The communications module 9 is used both for communication and for detecting a change in the automation component 3. The interface module 21 is used for data transfer and also for lockup. Lookup is used by the automation component 3 to determine which automation object 1 is connected.

The illustration according to FIG. 2 shows an object-specific information item 26 in a metalanguage. A tree structure 28 is apparent from FIG. 2. The tree structure 28 is shown by the indenting of the respective beginnings of the lines. Within this tree structure 28, an engine list 30 is formed in which, for example, a specific engine type 32 is shown. This engine type 32 can be described by various data. One data item has, for example, a value designation and a value. The value designation 34 MLFB indicates, for example, the order number of the engine. The value 35 of the order number is then stored as a string. Further value designations are, for example, the value designation 36 for a nominal speed Vnom and a value 37 of 0.00 provided for it. A further value designation 38 is, for example, the nominal current mom for which the value 39 of 14,500 is defined.

1-13. (canceled)

14. An automation object comprising:
an application; and
an object-specific information element that can be represented in the form of a metalanguage;
wherein the automation object is capable of transmitting the object-specific information element to a second automation object.

15. The automation object of claim 14 wherein the object-specific information element has a hierarchical structure.

16. The automation object of claim 14 wherein the object-specific information element pertains to the automation object.

17. The automation object of claim 16 wherein the object-specific information element pertains to the application.

18. The automation object of claim 17 wherein the application comprises a hardware application.

19. The automation object of claim 17 wherein the application comprises a software application.

20. The automation object of claim 16 wherein the object-specific information comprises parameter information.

21. The automation object of claim 16 wherein the object-specific information comprises interface information.

22. The automation object of claim 14 wherein the object-specific information is represented in the form of extensible mark-up language.

22. The automation object of claim 14 wherein the object-specific information is represented in a form that is translatable into extensible mark-up language without a loss of information.

23. A method of transmitting object-specific information from a first automation object to a second automation object comprising the step of transmitting information in the form of a metalanguage from the first automation object to the second automation object.

24. The method of claim 23 wherein the metalanguage is translatable into a more robust metalanguage without a loss of information.

25. The method of claim 23 wherein the object-specific information is stored in the first automation object.

26. The method of claim 23 further comprising the step of the second automation object detecting a change in an attribute of the first automation object.

27. The method of claim 26 wherein the step of detecting a change in an attribute of the first automation object is accomplished by a data reconciliation.

28. The method of claim 23 wherein the object-specific information has a hierarchical structure.

29. The method of claim 28 further comprising the step of placing the object-specific information into a data holding means in the second automation object as a function of the hierarchical structure.

30. The method of claim 23 wherein the step of transmitting information is performed as a consequence of the second automation object being in an initialization mode.
